(19) United States
(12) Patent Application Publication
(10) Pub. No.: US 2025/0076520 A1
(43) Pub. Date: Mar. 6, 2025

(54) INFORMER-BASED AUTONOMOUS SATELLITE POSITIONING ACCURACY PREDICTION METHOD AND APPARATUS

(71) Applicant: BEIJING JIAOTONG UNIVERSITY, Beijing (CN)

(72) Inventors: Debiao LU, Beijing (CN); Yu ZHANG, Beijing (CN); Baigen CAI, Beijing (CN); Jian WANG, Beijing (CN); Wei SHANGGUAN, Beijing (CN); Jiang LIU, Beijing (CN); Wei JIANG, Beijing (CN); Xiaohui BA, Beijing (CN); Linguo CHAI, Beijing (CN); Zhongli WANG, Beijing (CN)

(73) Assignee: BEIJING JIAOTONG UNIVERSITY, Beijing (CN)

(21) Appl. No.: 18/805,522

(22) Filed: Aug. 14, 2024

(30) Foreign Application Priority Data
Aug. 29, 2023 (CN) 202311093441.6

(51) Int. Cl. G01S 19/39; G01S 19/28; G01S 19/50

(52) U.S. Cl. CPC G01S 19/396; G01S 19/28; G01S 19/50

(57) ABSTRACT

The present application relates to an Informer-based autonomous satellite positioning accuracy prediction method and apparatus. The method includes: collecting satellite observation data of a train within a given operational section, there being an area where satellite signals are blocked within the given operational section, where the satellite observation data is satellite observation data collected by the train on the given operational section via a satellite positioning receiver; according to the satellite observation data on the given operational section, obtaining a prediction data set based on an effective value range of a preset three-dimensional position accuracy factor; and based on a preset accuracy prediction model, outputting an autonomous satellite positioning accuracy predictive value by taking the prediction data set as an input.

### TECHNICAL FIELD

The present application relates to the field of autonomous train positioning based on satellite navigation, and in particular, to an Informer-based autonomous satellite positioning accuracy prediction method and apparatus.

### BACKGROUND

With the development of train operation control systems, a train on-vehicle autonomous positioning method based on Global Navigation Satellite System (GNSS) is an important direction for research and application.

The prior art research on satellite positioning accuracy prediction methods during train operation mainly comprises satellite availability prediction methods, train trajectory prediction methods, etc. during train operation.

However, a train on-vehicle positioning receiver is affected by many factors during the propagation process of acquiring satellite navigation signals, including ionospheric delay, tropospheric delay, non line of sight (NLOS) signals of multipath effect, etc., resulting in signal delay in propagation paths, and thus leading to increased satellite positioning errors.

### SUMMARY

In view of the above problems, the object of the present application is to provide an Informer-based autonomous satellite positioning accuracy prediction method and apparatus.

According to a first aspect of the embodiments of the present application, provided is an Informer-based autonomous satellite positioning accuracy prediction method, including: collecting satellite observation data of a train within a given operational section, there being an area where satellite signals are blocked within the given operational section; where the satellite observation data is satellite observation data collected by the train on the given operational section via a satellite positioning receiver; according to the satellite observation data on the given operational section, obtaining a prediction data set based on an effective value range of a preset three-dimensional position accuracy factor; and based on a preset accuracy prediction model, outputting an autonomous satellite positioning accuracy predictive value by taking the prediction data set as an input.

Further, the method includes: collecting satellite observation data during train operation; obtaining a feature vector according to the satellite observation data during train operation; obtaining a training set according to the feature vector and the effective value range of the three-dimensional position accuracy factor; and based on an Informer model, training to obtain the accuracy prediction model by taking the training set as an input.

Further, the feature vector includes a feature vector of a single satellite, and the generating the feature vector includes: the collecting the satellite observation data during train operation, including: satellite elevation angle, azimuth angle, signal-to-noise ratio and satellite number; and obtaining the feature vector of the single satellite according to the satellite elevation angle, the azimuth angle, the satellite number and the signal-to-noise ratio.

Further, the feature vector includes a feature vector of all satellites, and the generating the feature vector includes: the collecting the satellite observation data during train operation, including: a sum of observation epochs under a total train operational time, a sum of a number of all visible satellites under all epochs, observation time, a number of visible satellites, pseudo-range residuals and geometric dilution of precision values; obtaining a pseudo-range residual matrix according to the pseudo-range residuals; obtaining a satellite pseudo-residual mean square error according to the pseudo-range residual matrix; obtaining a data set of the number of all visible satellites in all epochs according to the sum of the number of all visible satellites in all epochs; and obtaining the feature vector of all satellites according to the observation time, the number of visible satellites, the data set of the number of all visible satellites under all epochs, the pseudo-range residual matrix, the satellite pseudo-residual mean square error and the geometric dilution of precision values.

Further, the based on an Informer model, obtaining the accuracy prediction model by taking the training set as an input includes: based on the Informer model, adjusting model parameters by taking the training set as an input, and outputting the positioning accuracy predictive value; acquiring actual sample values according to the positioning accuracy predictive value; obtaining a loss function value according to the sum of observation epochs under the total train operational time, the positioning accuracy predictive value and the actual sample values; based on a preset Adam optimizer, determining whether the Informer model training has ended according to the loss function value; and obtaining the accuracy prediction model in response to determining that the Informer model training has ended.

Further, the based on a preset Adam optimizer, determining whether the Informer model training has ended according to the loss function value includes: setting a loss function gradient threshold of the Adam optimizer according to the loss function value; continuing the Informer model training if the loss function value is greater than the loss function gradient threshold; and ending the Informer model training if the loss function value is not greater than the loss function gradient threshold.

According to a second aspect of the embodiments of the present application, provided is an Informer-based autonomous satellite positioning accuracy prediction apparatus, including: a data collection module, configured to collect satellite observation data of a train within a given operational section, there being an area where satellite signals are blocked within the given operational section; where the satellite observation data is satellite observation data collected by the train on the given operational section via a satellite positioning receiver; a data preprocessing module, configured to, according to the satellite observation data on the given operational section, obtain a prediction data set based on an effective value range of a preset three-dimensional position accuracy factor; and a prediction module, configured to, based on a preset accuracy prediction model, output an autonomous satellite positioning accuracy predictive value by taking the prediction data set as an input.

Further, the device includes a network training module, configured to collect satellite observation data during train operation; obtain a feature vector, according to the satellite observation data during train operation; obtain a training set according to the feature vector and the effective value range of the preset three-dimensional position accuracy factor; and based on an Informer model, obtain an accuracy prediction model by taking the training set as an input.

According to a third aspect of the embodiments of the present application, provided is an electronic device, including: a processor; and a memory, configured to store processor executable instructions; the processor being configured to read executable instructions from the memory and execute the instructions to implement an Informer-based autonomous satellite positioning accuracy prediction method provided in the first aspect of the present application.

According to a fourth aspect of the embodiments of the present application, provided is a computer-readable storage medium, in which computer program instructions are stored. When the program instructions are executed by a processor, steps of the Informer-based autonomous satellite positioning accuracy prediction method provided by the first aspect of the present application is implemented.

The technical solutions provided by the embodiments of the present application may include the following beneficial effects:

In the present application, satellite observation data within a given operational section are input, and a positioning accuracy predictive value is obtained based on a preset accuracy prediction model. The predictive value represents the degree to which the satellite observation data deviates from the actual result. By means of this method, the positioning accuracy on the corresponding section can be predicted based on a machine learning method, so as to predict the satellite positioning accuracy of a given operational section in advance, thereby providing a basis for whether providing a positioning fusion for areas where the satellite positioning accuracy does not meet a threshold.

### BRIEF DESCRIPTION OF THE DRAWINGS

For a clearer illustration of technical solutions in one or more embodiments of this specification or in the prior art, the accompanying drawings that need to be used in the description of the embodiments or prior art will be briefly introduced hereinafter. It is obvious that the accompanying drawings described hereinafter are just some of the embodiments recorded in this specification. For those of ordinary skill in the art, other accompanying drawings may be obtained from these accompanying drawings without creative labor.

FIG. 1 is a utilization flowchart of an Informer-based autonomous satellite positioning accuracy prediction method illustrated according to an exemplary embodiment;

FIG. 2 is a training and testing flowchart of an Informer-based autonomous satellite positioning accuracy prediction method illustrated according to an exemplary embodiment; and

FIG. 3 is a schematic diagram of an Informer-based autonomous satellite positioning accuracy prediction apparatus illustrated according to an exemplary embodiment.

### DETAILED DESCRIPTION

In order to facilitate those skilled in the art to better understand the technical solutions in one or more embodiments of this specification, the technical solutions in one or more embodiments of this specification will be described clearly and completely hereinafter in conjunction with the accompanying drawings in one or more embodiments of this specification. Obviously, the described embodiments are only a part of the embodiments of this specification, rather than all the embodiments. All other embodiments derived by those skilled in the art without creative efforts based on one or more embodiments of this specification should fall within the protection scope of the present application.

In an embodiment of the present application, data are collected according to multiple operations, and these data are collectively referred to as historical data. Satellite observation data within a given operational section and satellite observation data during a train operation are both historical data. In order to distinguish these two data, the present application introduces a concept of satellite ephemeris, which is also known as Two-Line Orbital Element (TLE), is an expression used to describe a position and a speed of a spacecraft, and can describe the satellite's past, present and future position at any time. That is, by means of satellite ephemeris, satellites in different states can be distinguished. Satellites in different states have different deviations in measured data. Therefore, in the embodiment of the present application, the difference between the satellite observation data within a given operational section and the satellite observation data during operation process is the different satellite states corresponding to the two satellite observation data. Since the satellite states in different time periods are different, the satellite observation data corresponding to the satellite state in the previous time period can be used as the satellite observation data during operation process, and the observation data corresponding to the satellite state in the next time period can be used as the satellite observation data on the given operational section. According to the train operational timetable, the positioning accuracy of the corresponding section is predicted.

The satellite observation data on the given operational section are used to predict the accuracy of autonomous satellite positioning, when used, as in an exemplary method I. The satellite observation data during operation process are used to train and test the Informer model, as in an exemplary method II.

### Exemplary Method I

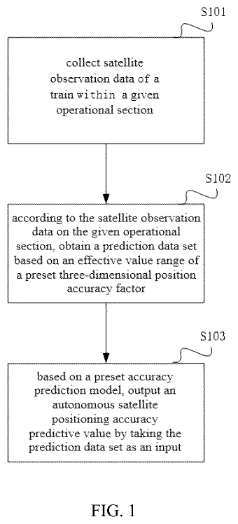

As shown in FIG. 1, an embodiment of the present application provides an Informer-based autonomous satellite positioning accuracy prediction method, including the following steps: In step S101, satellite observation data of a train within a given operational section are collected.

In the embodiment of the present application, there is an area where satellite signals are blocked within the given operational section, where the satellite observation data is satellite observation data collected by the train on the given operational section via a satellite positioning receiver.

In step S102, according to the satellite observation data on the given operational section, a prediction data set is obtained based on an effective value range of a preset three-dimensional position accuracy factor.

The observation parameter feature quantities related to the surrounding environment features are extracted from the satellite observation data on the given operational section. The sum of the observation epochs under the total train operational time is N, and the sum of the number of all visible satellite under the N epochs when the train is operating is Sn.

At the a-th epoch of train operation, the observed satellite navigation related parameters are extracted to obtain the observation time tₐ, number svₐ of visible satellites, and elevation angle elᵢ, azimuth angle azᵢ, signal-to-noise ratio SNRᵢ, pseudo-range residual εᵢ, satellite number prnᵢ, geometric dilution of precision value DOPₐ=[PDOPₐ, HDOPₐ, VDOPₐ] of the i-th satellite of the SVₐ a satellites, where a=1,2, . . . N, i=1,2, . . . Sn.

Epoch: the measured time interval or frequency of data, which is the beginning of a marked time in the calendar. In order to compare the observation results at different times, it is necessary to indicate the observation time corresponding to the observation data. This time is referred to as the observation epoch.

Number of visible satellites: the number of satellites visible to the GPS satellite navigation system.

Satellite number: in a system (GPS or BD), one satellite corresponding to a unique prnᵢ.

Geometric dilution of precision (DOP) measures the impact of the spatial geometric distribution of observation satellites on positioning accuracy. The geometric dilutions of precision used in the present application include the following:

Three-dimensional position dilution of precision (PDOP): the root value of the sum of the squared errors of latitude, longitude and elevation; Horizontal dilution of precision (HDOP): the root value of the sum of the squared errors of latitude and longitude; Vertical dilution of precision (VDOP): measuring the relationship between satellite and altitude as accuracy.

The higher the value of the geometric DOP, the greater the positioning error, and the lower the positioning accuracy. Higher PDOP values correspond to lower positioning accuracy, and vice versa.

The pseudo-range residual matrix of the epoch is calculated by using the following formula:

Λₐ=[ε₁, ε₂, . . . εSVₐ]^{T}
where T denotes a transpose symbol, a=1,2, . . . N.

The mean square error of satellite pseudo-residuals is calculated by using the following formula:

RSSₐ=\sqrt{Λₐ^{T}Λₐ}

The feature vector of the i-th satellite during the a-th epoch is formulated as follows:

Sᵢ^{a}=[prnᵢ, elᵢ, azᵢ, SNRᵢ]

The feature vector of all satellites during the a-th epoch is:

fvₐ=[tₐ, svₐ, S₁, . . . , S_{Sn}, Λₐ, RSSₐ, DOPₐ]
where S₁, . . . , S_{Sn} is a data set of a number of all visible satellites across all epochs.

The prediction data set is obtained by using anomalies in the geometric DOP values within the feature variables and excluding outliers in the observation data by taking PDOP<6 as a rule.

In step S103, based on a preset accuracy prediction model, an autonomous satellite positioning accuracy predictive value is output by taking the prediction data set as an input.

The predetermined accuracy prediction model includes a temporal series position encoding module, a probabilistic sparse self-attention mechanism module, and a decoder module.

In the present application, the temporal series position encoding module is configured to: preprocess data by using the temporal series position encoding module, and generate input data:
where the temporal series are input by employing the combination of a scalar projection module, a local timestamp module and a global timestamp module, so as to achieve temporal series position encoding, thereby obtaining an input feature vector.

With regard to the local timestamp module: fixed position embedding is firstly used to maintain local context, the position encoding is mapped by using a local timestamp, and the position encoding of the moment in the time series is mapped by using the local timestamp PE(pos)ₚ of the moment t in the time series xᵢ, with a formula as follows:

$$PE ( pos , 2 j ) = \begin{matrix}sin ( \frac{pos}{{( 2 {L}_{x} )}^{\frac{j}{{d}_{mod el}}}} ) , \\ cos ( \frac{pos}{{( 2 {L}_{x} )}^{\frac{j}{{d}_{mod el}}}} ) ,\end{matrix}$$

where pos is a fixed position at the moment t in the time series, j=1,2, . . . d_{model}, L_{X} is a length of the input series.

With regard to the global timestamp module: global timestamps are represented combined with four types of timestamps SE(pos)ₚ hours, days, weeks, months, in order to enhance the global position context and local temporal context of the temporal series input, where p=1,2,3,4. The projection vector uᵢ^{t} of the one-dimensional convolution input scalar xᵢ^{t} is combined with the local timestamp PE(pos)ₚ by dimension alignment. The input series xᵢ input x_{feed}^{t}[i] at time t is represented by the following formula:

$$\begin{matrix}{x}_{feed [ i ]}^{f} = α {u}_{i} + P E ( {L}_{x} \times ( t - 1 ) + i ) + {\sum }_{p = 1}^{4} {SE ( {L}_{x} \times ( t - 1 ) + i )}_{p} & i = 1 ,\end{matrix} … , {L}_{x} ,$$

where α∈[0,1] represents scalar projection coefficients.

With regard to the scalar projection module: in order to align the dimensions, assuming an input time series xᵢ at moment t with scalar value xᵢ^{t}, scalar projection is implemented. The convolution and size are set to 3 and the stride to 1, a projection uᵢ^{t} of scalar xᵢ^{t} to the projected vector is implemented by using a number d_{model} of one-dimensional convolution filters of the aforementioned size, where d_{model} represents the dimension of the model, resulting in the input feature vector.

In the present application, the probabilistic sparse self-attention mechanism module inputs a feature vector, and outputs the processed feature vector.

Based on the sparsity and long-tail distribution characteristics of self-attention values, a sample value of input feature vectors with higher attention values is selected for subsequent self-attention mechanism calculations, which reduces the number of initial input samples, lowers computational complexity, and eases computational load.

The probabilistic sparse self-attention mechanism preliminarily filters samples by comparing the similarity between the distribution of self-attention values and uniform distribution, so as to obtain a dominant dot product pair, namely a dominant query. According to the self-attention mechanism, the corresponding Q, K, V are obtained. According to the definition of self-attention, it can be seen that the self-attention values can be expressed as follows:

$$A ( Q , K , V ) = soft max ( \frac{Q {K}^{T}}{\sqrt{d}} ) V$$

where d is the feature dimension, softmax represents the probability mapping function, Q is query, K is key, V is value.

$$A ( {q}_{i} , K , V ) = {\sum }_{j} \frac{k ( {q}_{i} , {k}_{j} )}{{\sum }_{l} k ( {q}_{i} , {k}_{l} )} {v}_{j} = {E}_{p ( {k}_{j} \vert {q}_{i} )} [ {v}_{j} ]$$

$$k ( {q}_{i} , {k}_{j} ) = {e}^{\frac{{q}_{i} {k}_{j}^{T}}{\sqrt{σ}}}$$

where qᵢ is the i-th query, kⱼ is the j-th key, vⱼ is the j-th value, σ is the input dimension.

Using the KL divergence method for quantitative analysis, the evaluation criterion for the dominant query is obtained as follows,

$$M ( {q}_{i} , K ) = ln {\sum }_{j = 1}^{{L}_{K}} {e}^{\frac{{q}_{i} {k}_{j}^{T}}{\sqrt{σ}}} - \frac{1}{{L}_{K}} {\sum }_{j = 1}^{{L}_{K}} \frac{{q}_{i} {k}_{j}^{T}}{\sqrt{σ}}$$

where L_{K} is the number of keys, further approximating to reduce computational complexity.

$$\tilde{M} ( {q}_{i} , K ) = {max}_{j} \frac{{q}_{i} {k}_{j}^{T}}{\sqrt{σ}} - \frac{1}{{L}_{K}} {\sum }_{j = 1}^{{L}_{K}} \frac{{q}_{i} {k}_{j}^{T}}{\sqrt{σ}}$$

\tilde{M}(qᵢ, K) is calculated by selecting L_{Q}−ln_{(L}_{_{K}}₎ dot product pairs as weights, and n dot product pairs with the highest weights are filtered, thereby reducing complexity and implementing the probabilistic sparse self-attention mechanism. At this point, the self-attention values can be represented as:

$$\overline{A} ( Q , K , V ) = soft max ( \frac{\overline{Q} {K}^{T}}{\sqrt{d}} ) V$$

where Q̅ is the vector selected from the Q matrix.

A probabilistic sparse self-attention result is output to the self-attention distillation layer. Through a one-dimensional convolution layer, an activation function layer and a pooling layer, a halving of the input sequence is achieved and computational complexity is reduced. The features of the multi-head self-attention layer are mapped and concatenated, and used as input to the decoder.

Multi-head self-attention, Query, Key and Value are first subjected to a linear transformation, and then input to a scaled dot product A. It is noted that the above operations are performed h times, hence the term is referred to as multi-head, one head is calculated for each time, with no shared parameters between the heads. Parameters for linear transformation of Q, K, V vary each time. Then, the results of the scaled dot product A for h times are concatenated, followed by another linear transformation and the obtained value is used as the result of the multi-head attention.

In the present application, the decoder module generates a long sequence output through a forward process, and outputs the positioning accuracy prediction values.

The decoder module includes a probabilistic sparse self-attention layer, a multi-head self-attention layer, and a fully connected layer. The decoder inputs encoder-concatenated feature mapping, and simultaneously inputs the input sequence covering the predicted position. Part of time series are input by using a combination of scalar projection, local timestamp and global timestamp, so as to implement temporal series position encoding. Using a sparse self-attention mechanism and a multi-head self-attention layer with the same probabilistic as the probabilistic of the encoder, the predicted position results are output through the fully connected layer, thereby achieving one-step prediction to generate positioning accuracy prediction values.

### Exemplary Method II

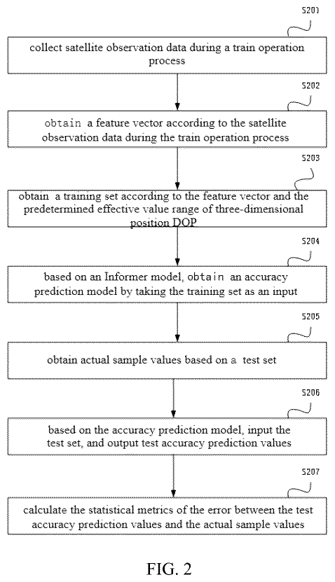

As shown in FIG. 2, an embodiment of the present application provides a training and testing process for an Informer-based autonomous satellite positioning accuracy prediction method, including the following steps: In step S201, satellite observation data during a train operation process are collected.

In step S202, a feature vector is obtained according to the satellite observation data during the train operation process.

In step S203, a training set is obtained according to the predetermined effective value range of three-dimensional position DOP and the feature vector.

Observation parameter feature quantities related to the surrounding environment features are extracted from the satellite observation data during the train operation process. The total number of observation epochs under the total train operational duration is N, and the sum of number of all visible satellites under the N epochs during the train operation process is Sn.

During the a-th epoch of the train operation, the observed satellite navigation related parameters are extracted to obtain the observation time tₐ, number svₐ of visible satellites, and the elevation angle elᵢ, azimuth azᵢ, signal-to-noise ratio SNRᵢ, pseudo-range residual E, satellite number prnᵢ, and geometric Dilution of Precision value DOPₐ=[PDOPₐ, HDOPₐ,VDOPₐ] of the i-th satellite of the svₐ satellites, where a=1,2, . . . N,i=1,2, . . . Sn.

The higher the value of the geometric DOP, the greater the positioning error, and the lower the positioning accuracy. Higher PDOP corresponds to lower positioning accuracy, and vice versa.

The pseudo-range residual matrix of the epoch is calculated using the following formula:

Λₐ=[ε₁, ε₂, . . . εSVₐ]^{T}
where a=1,2, . . . N.

The mean square error of satellite pseudo-residuals is calculated by using the following formula:

RSSₐ=\sqrt{Λₐ^{T}Λₐ}

The feature vector of the i-th satellite during the a-th epoch is formulated as follows:

Sᵢ^{a}=[prnᵢ, elᵢ, azᵢ, SNRᵢ]

The feature vector of all satellites during the a-th epoch is:

fvₐ=[tₐ, svₐ, S₁, . . . , S_{Sn}, Λₐ, RSSₐ, DOPₐ]
where S₁, . . . , S_{Sn} is a data set of all visible satellites across all epochs.

The processed feature vector is obtained by using anomalies in the geometric DOP values within the feature variables and excluding outliers in the observation data by taking PDOP<6 as a rule.

The processed feature vector is divided into a training set and a test set according to a ratio of 3:1.

In step S204, based on an Informer model, an accuracy prediction model is obtained by taking the training set as an input.

In an embodiment of the present application, based on the Informer model, model parameters are adjusted by taking the training set as an input, and the positioning accuracy prediction values are output;

The actual sample values are acquired according to the positioning accuracy prediction values.

In an embodiment of the present application, for an area where satellite signals are blocked, the positioning accuracy inevitably decreases; therefore, the training samples themselves are not accurate data. Using inaccurate data to train the network may lead to an uncontrollable problem. To address the above problem, it is necessary to obtain actual values in the present application, namely the actual coordinates of the vehicle and the deviation from the coordinates measured by the satellite. It can be understood that each coordinate point that vehicle passes when traveling corresponds an actual sample value and a positioning accuracy prediction value.

After acquiring the actual sample values, a loss function value is obtained by using the actual sample values and the positioning accuracy prediction values; and then the model's loss function is evaluated by using the loss function value, thereby improving model accuracy. That is, the training accuracy of the model is enhanced by converting inaccurate data into relatively accurate data.

The specific process for determining the loss function value is as follows: obtaining the loss function value based on the positioning accuracy prediction values and the actual sample values, by using the following formula:

$$MSE = \frac{1}{m} {\sum }_{i = 1}^{m} {( f ( {x}_{i} ) - {y}_{i} )}^{2}$$

where the predicted values are denoted by f(xᵢ), and the actual values are denoted by yᵢ, where m represents the total number of samples. The predicted values correspond to the actual values, and the mean square error is denoted by MSE.

In an embodiment of the present application, during the training process, the parameters of the loss function are constantly changing. Therefore, multiple rounds of evaluation are necessary for evaluating the loss function. For example, the sample training process is divided into five stages. Appropriate training samples are allocated for each stage, and the corresponding actual sample values are determined based on the training samples of each stage. After each stage is completed, the loss function value of that stage is first determined using the training samples and actual sample values of the corresponding stage, and then the loss function value of that stage is evaluated by using the loss function value of that stage, based on the Adam optimizer. And then, the loss function is evaluated once each stage has ended, until it is determined that the model no longer needs training.

The specific process of each round of evaluation is described hereinafter:

A loss function gradient threshold of the Adam optimizer is set based on the loss function value;

If the loss function value is greater than the loss function gradient threshold, the loss function is stored in the loss function gradient threshold, and the training of the Informer model is continued; If the loss function value is not greater than the loss function gradient threshold, the training of the Informer model ends, and the accuracy prediction model is obtained.

In an embodiment of the present application, when evaluating the loss function of the first stage, the loss function gradient threshold is a preset value. Thereafter, the loss function gradient threshold of each stage is the loss function value of the previous stage.

The parameters of the Informer model are changed to obtain new prediction values, the new prediction values and actual sample values are used to calculate a new loss function value, the new loss function value is compared with the loss function gradient threshold in which the old loss function value is stored. If over a period of time, the new loss function value is less than the loss function gradient threshold in which the old loss function value is stored, it is determined that the model parameters cannot be further improved, and the model training process is terminated.

In step S205, actual sample values are obtained according to a test set.

In step S206, based on the accuracy prediction model, the test set is input, and test accuracy prediction values are output.

In step S207, the statistical metrics of the error between the test accuracy prediction values and the actual sample values are calculated.

The statistical metrics MAE, RMSE of the error between prediction values and actual values are calculated.

A mean absolute error (MAE) refers to the average value of the distances between the model prediction values and the actual sample values, with a formula as follows:

$$MAE = \frac{1}{m} {\sum }_{i = 1}^{m} \vert f ( {x}_{i} ) - {y}_{i} \vert$$

A root mean square error (RMSE) is the square root of a divided ratio of the sum of the squares of the distances between the model prediction values and actual sample values divided by the total duration time, used to measure the deviation between the predicted values and actual values, with a formula as follows:

$$RMSE = \sqrt{\frac{1}{m} {\sum }_{i = 1}^{m} {( f ( {x}_{i} ) - {y}_{i} )}^{2}}$$

### Exemplary Apparatus

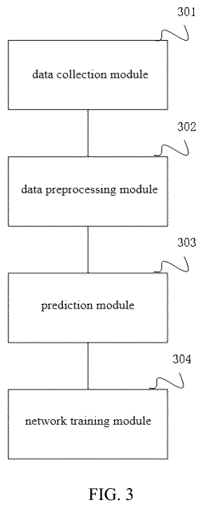

In an embodiment of the present application, as shown in FIG. 3, the device includes a data collection module 301, a data preprocessing module 302, a prediction module 303, and a network training module 304.

The data collection module 301 is configured to collect satellite observation data of a train within a given operational section, there being an area where satellite signals are blocked within the given operational section; where the satellite observation data is satellite observation data collected by the train on the given operational section via a satellite positioning receiver.

The data preprocessing module 302 is configured to, according to the satellite observation data on the given operational section, obtain a prediction data set based on an effective value range of a preset three-dimensional position accuracy factor.

The prediction module 303 is configured to, based on a preset accuracy prediction model, output an autonomous satellite positioning accuracy predictive value by taking the prediction data set as an input.

The network training module 304 is configured to collect satellite observation data during the train operation process; obtain a feature vector according to the satellite observation data during train operation; obtain a training set according to the feature vector and the effective value range of the preset three-dimensional position accuracy factor; and based on an Informer model, obtain an accuracy prediction model by taking the training set as an input.

### Exemplary Electronic Device

An embodiment of the present application provides an electronic device, including one or more processors, as well as internal and external memories. The internal memory stores instructions that, when executed by the one or more processors, cause the one or more processors to execute an Informer-based autonomous satellite positioning accuracy prediction method as described in any of the previous embodiments.

The processor is configured to execute all or part of the steps of an Informer-based autonomous satellite positioning accuracy prediction method as described in the embodiment. The memory is configured to store various types of data, which may include instructions for any application or method in the electronic device, as well as application-related data.

The processor can be realized by an Application Specific Integrated Circuit (ASIC), a Digital Signal Processor (DSP), a Programmable Logic Device (PLD), a Field Programmable Gate Array (FPGA), a controller, a microcontroller, a microprocessor, or other electronic components, and used to execute an Informer-based autonomous satellite positioning accuracy prediction method as described in the embodiments.

### Computer Storage Medium

The computer-readable storage medium stores computer programs, and when the computer programs are executed by one or more processors, an Informer-based autonomous satellite positioning accuracy prediction method as described in any of the previous embodiments is implemented.

Specific embodiments of this specification have been described above. Other embodiments fall within the scope of the appended claims. In some cases, the actions or steps recorded in the claims can be performed in a different order than described in the embodiments and still achieve the desired results. Furthermore, the processes depicted in the accompanying drawings do not necessarily require the specific sequence or sequential order shown to achieve the desired results. In some implementations, multitasking and parallel processing may also be possible or advantageous.

In the 1930s, it was clear to distinguish whether an improvement in a technology was a hardware improvement (such as an improvement in the structure of a circuit such as a diode, a transistor and a switch) or a software improvement (an improvement in the methodology process).

However, as technology has developed, many of today's methodology process improvements can be seen as direct improvements to hardware circuit structures. Designers almost invariably obtain the corresponding hardware circuit structures by programming improved methodology processes into hardware circuits. Thus, it cannot be said that an improvement in a methodology process cannot be realized with hardware entity modules. For example, a Programmable Logic Device (PLD) (such as a Field Programmable Gate Array, FPGA) is a type of integrated circuit whose logic function is determined by user programming. A designer can “integrate” themselves a digital system on a PLD by programming without the need for a chip manufacturer to design and produce a dedicated integrated circuit chip. Moreover, today, instead of manually manufacturing integrated circuit chips, this programming is mostly replaced by “logic compiler” software, similar to the software compilers used when writing program development, and the source code to be compiled is also written in a specific programming language known as Hardware Description Language (HDL), which is not only one but many, such as ABEL, AHDL, Confluence, CUPL, HDCal, JHDL, Lava, Lola, MyHDL, PALASM, RHDL, etc., with the most commonly used being VHDL and Verilog. Those skilled in the art should also understand that by simply logically programming the methodology process with the aforementioned hardware description languages and programming into the integrated circuit, the hardware circuit that implements the logical method process can be easily obtained.

The controller can be implemented in any appropriate manner. For example, the controller may take the form of, for example, a microprocessor or processor and computer-readable media storing computer-readable program code (e.g., software or firmware) that can be executed by the (micro)processor, logic gates, switches, Application Specific Integrated Circuits (ASICs), programmable logic controllers and embedded microcontrollers. Examples of the controller include, but are not limited to the following microcontrollers such as ARC 625D, Atmel AT91SAM, Microchip PIC18F26K20, and Silicone Labs C8051F320. The memory controller can also be implemented as part of the control logic of the memory. Those skilled in the art also learn that in addition to implementing the controller as purely computer-readable program code, it is entirely possible to make the controller perform the same functions in the form of logic gates, switches, Application Specific Integrated Circuits, programmable logic controllers, and embedded microcontrollers by logically programming the method steps. Therefore, such a controller can be considered a hardware component, and the apparatuses included therein for performing various functions can also be considered as the structure within the hardware component. Or even, the apparatus used to implement various functions can be considered as both a software module for implementing methods and a structure within the hardware component.

The systems, apparatuses, modules, or units described in the above embodiments can be specifically implemented by a computer chip or entity, or by a product with certain functions. A typical implementation device is a computer. Specifically, the computer can be, for example, a personal computer, a laptop, a cell phone, a camera phone, a smart phone, a personal digital assistant, a media player, a navigation device, an email device, a gaming console, a tablet computer, a wearable device, or a combination of any devices in these devices.

For ease of description, the above apparatus, when described, is functionally divided into various units for separate description. Certainly, in the implementation of the embodiments of this specification, the functions of the various units can be implemented in the same or multiple software and/or hardware.

Those skilled in the art should understand that one or more embodiments of this specification may be provided as methods, systems, or computer program products. Therefore, one or more embodiments of this specification can take the form of a complete hardware embodiment, a complete software embodiment, or an embodiment combining software and hardware aspects. Moreover, this specification can take the form of a computer program product implemented on one or more computer-readable storage media (including but not limited to disk storage, CD-ROM, optical storage, etc.) containing computer usable program code.

This specification is described with reference to flowcharts and/or block diagrams of methods, devices (systems), and computer program products according to the embodiments of this specification. It should be understood that each flow and/or block in the flowchart and/or block diagrams as well as combinations of flows and/or blocks in the flowchart and/or block diagrams can be implemented by computer program instructions. These computer program instructions can be provided to a general-purpose computer, a special-purpose computer, an embedded processor, or a processor of other programmable data processing device to create a machine, so that by means of instructions executed by the computer or the processor of other programmable data processing device, apparatuses for implementing the functions specified in one flow or multiple flows and/or one block or multiple blocks in the flowchart and/or block diagrams are generated.

These computer program instructions may also be stored in a computer-readable memory that can direct a computer or other programmable data processing device to operate in a specific way, so that instructions stored in the computer-readable memory generate an article of manufacture including instruction apparatuses, which implement the functions specified in one flow or multiple flows and/or one block or multiple blocks in the flowchart and/or block diagrams.

These computer program instructions may also be loaded onto a computer or other programmable data processing device, so that a series of operational steps are performed on the computer or other programmable device to generate a computer-implemented process, so that instructions executed on the computer or other programmable device provide steps for implementing the functions specified in one flow or multiple flows and/or one block or multiple blocks in the flowchart and/or block diagrams.

In a typical configuration, computing devices include one or more processors (CPU), input/output interfaces, network interfaces, and a memory.

The memory may include forms such as non-permanent memory, random access memory (RAM) and/or non-volatile memory in computer-readable media, such as read-only memory (ROM) or flash memory (flash RAM). Memory is an example of computer-readable media.

Computer-readable media include permanent and non-permanent, removable and non-removable media, implemented in any method or technology for storage of information. Information can be computer-readable instructions, data structures, program modules, or other data. Examples of computer storage media include, but are not limited to, Phase-Change Memory (PRAM), Static Random-Access Memory (SRAM), Dynamic Random-Access Memory (DRAM), other types of Random-Access Memory (RAM), Read-Only Memory (ROM), Electrically Erasable Programmable Read-Only Memory (EEPROM), flash memory or other memory technologies, Compact Disc Read-Only Memory (CD-ROM), Digital Versatile Disks (DVD) or other optical storage, magnetic cassettes, magnetic tape, magnetic disk storage, or other magnetic storage devices, or any other non-transmission medium that can be used to store information accessible by a computing device. As defined herein, computer-readable media do not include transitory media such as modulated data signals and carrier waves.

It should also be noted that the terms “including”, “containing”, or any other variation thereof are intended to cover non-exclusive inclusion, so that a process, method, article, or device that includes a set of elements includes not only those elements but also other elements that are not expressly listed or that are inherent to such process, method, article, or device. Without further limitation, an element defined by the phrase “including a . . . . . .” does not preclude the existence of another identical element in the process, method, article or device including the element.

One or more embodiments of this specification can be described in the general context of computer-executable instructions, such as program modules, being executed by a computer. Generally, program modules include routines, programs, objects, components, data structures, etc., that perform particular tasks or implement particular abstract data types. One or more embodiments of this specification can also be practiced in a distributed computing environment where tasks are performed by remote processing devices that are linked through a communications network. In a distributed computing environment, program modules can be located in both local and remote computer storage media, including storage devices.

Each embodiment of this specification is described in a progressive manner; the same or similar parts of each similar refer to each other, and the focus of each embodiment is the differences from the other embodiments. In particular, since system embodiments are fundamentally similar to method embodiments, the description is relatively simple, and relevant parts refer to part of the description in the method embodiments.

The foregoing is only an embodiment of the present application and is not used to limit the present application. For those skilled in the art, the present application may have various changes and variations. Any modifications, equivalents, improvements, etc., made within the spirit and principle of the present application should be included within the scope of the claims of the present application.

1. An Informer-based autonomous satellite positioning accuracy prediction method, comprising:
collecting satellite observation data of a train within a given operational section, there being an area where satellite signals are blocked within the given operational section;
wherein the satellite observation data is satellite observation data collected by the train on the given operational section via a satellite positioning receiver;
according to the satellite observation data on the given operational section, obtaining a prediction data set based on an effective value range of a preset three-dimensional position accuracy factor; and
based on a preset accuracy prediction model, outputting an autonomous satellite positioning accuracy predictive value by taking the prediction data set as an input.

2. The method according to claim 1, further comprising:
collecting satellite observation data during train operation;
obtaining a feature vector according to the satellite observation data during train operation;
obtaining a training set according to the feature vector and the effective value range of the three-dimensional position accuracy factor; and
based on an Informer model, training to obtain the accuracy prediction model by taking the training set as an input.

3. The method according to claim 2, wherein the feature vector comprises a feature vector of a single satellite, and the generating the feature vector comprises:
the collecting the satellite observation data during train operation, comprising: satellite elevation angle, azimuth angle, signal-to-noise ratio and satellite number; and
obtaining the feature vector of the single satellite according to the satellite elevation angle, the azimuth angle, the satellite number and the signal-to-noise ratio.

4. The method according to claim 2, wherein the feature vector comprises a feature vector of all satellites, and the generating the feature vector comprises:
the collecting the satellite observation data during train operation, comprising: a sum of observation epochs under a total train operational time, a sum of a number of all visible satellites under all epochs, observation time, a number of visible satellites, pseudo-range residuals and geometric dilution of precision values;
obtaining a pseudo-range residual matrix according to the pseudo-range residuals;
obtaining a satellite pseudo-residual mean square error according to the pseudo-range residual matrix;
obtaining a data set of the number of all visible satellites in all epochs according to the sum of the number of all visible satellites in all epochs; and
obtaining the feature vector of all satellites according to the observation time, the number of visible satellites, the data set of the number of all visible satellites under all epochs, the pseudo-range residual matrix, the satellite pseudo-residual mean square error and the geometric dilution of precision values.

5. The method according to claim 4, wherein the based on an Informer model, obtaining the accuracy prediction model by taking the training set as an input comprises:
based on the Informer model, adjusting model parameters by taking the training set as an input, and outputting the positioning accuracy predictive value;
acquiring actual sample values according to the positioning accuracy predictive value;
obtaining a loss function value according to the sum of observation epochs under the total train operational time, the positioning accuracy predictive value and the actual sample values;
based on a preset Adam optimizer, determining whether the Informer model training has ended according to the loss function value; and
obtaining the accuracy prediction model in response to determining that the Informer model training has ended.

6. The method according to claim 5, wherein the based on a preset Adam optimizer, determining whether the Informer model training has ended according to the loss function value comprises:
setting a loss function gradient threshold of the Adam optimizer according to the loss function value;
continuing the Informer model training if the loss function value is greater than the loss function gradient threshold; and
ending the Informer model training if the loss function value is not greater than the loss function gradient threshold.

7. An Informer-based autonomous satellite positioning accuracy prediction apparatus, comprising:
a data collection module, configured to collect satellite observation data of a train within a given operational section, there being an area where satellite signals are blocked within the given operational section;
wherein the satellite observation data is satellite observation data collected by the train on the given operational section via a satellite positioning receiver;
a data preprocessing module, configured to, according to the satellite observation data on the given operational section, obtain a prediction data set based on an effective value range of a preset three-dimensional position accuracy factor; and
a prediction module, configured to, based on a preset accuracy prediction model, output an autonomous satellite positioning accuracy predictive value by taking the prediction data set as an input.

8. The apparatus according to claim 7, further comprising:
a network training module, configured to collect satellite observation data during train operation; obtain a feature vector according to the satellite observation data during train operation;
obtain a training set according to the feature vector and the effective value range of the preset three-dimensional position accuracy factor; and based on an Informer model, obtain an accuracy prediction model by taking the training set as an input.

9. An electronic device, comprising:
a memory, configured to store computer programs; and
a processor, configured to implement steps of the Informer-based autonomous satellite positioning accuracy prediction method according to any one of claims 1 to 6 upon executing the computer programs.

10. A computer-readable storage medium, wherein a computer program is stored in the computer-readable storage medium, and when the computer program is executed by a processor, steps of the Informer-based autonomous satellite positioning accuracy prediction method according to claim 1 are implemented.

11. A computer-readable storage medium, wherein a computer program is stored in the computer-readable storage medium, and when the computer program is executed by a processor, steps of the Informer-based autonomous satellite positioning accuracy prediction method according to claim 2 are implemented.

12. A computer-readable storage medium, wherein a computer program is stored in the computer-readable storage medium, and when the computer program is executed by a processor, steps of the Informer-based autonomous satellite positioning accuracy prediction method according to claim 3 are implemented.

13. A computer-readable storage medium, wherein a computer program is stored in the computer-readable storage medium, and when the computer program is executed by a processor, steps of the Informer-based autonomous satellite positioning accuracy prediction method according to claim 4 are implemented.

14. A computer-readable storage medium, wherein a computer program is stored in the computer-readable storage medium, and when the computer program is executed by a processor, steps of the Informer-based autonomous satellite positioning accuracy prediction method according to claim 5 are implemented.

15. A computer-readable storage medium, wherein a computer program is stored in the computer-readable storage medium, and when the computer program is executed by a processor, steps of the Informer-based autonomous satellite positioning accuracy prediction method according to claim 6 are implemented.
